(19) United States
(12) Patent Application Publication
(10) Pub. No.: US 2024/0336342 A1
(43) Pub. Date: Oct. 10, 2024

(54) PROPULSION SYSTEM HAVING INTEGRATED ELECTRIC MOTOR AND DISCONNECT CLUTCH AND METHOD OF OPERATING SAME

(71) Applicant: Caterpillar Inc., Peoria, IL (US)

(72) Inventors: Matthew E. Giannis, Lisle, IL (US); Joshua W. Dorothy, Dunlap, IL (US); Michael J. Barngrover, Brimfield, IL (US); John M. Seipold, Peoria, IL (US); Mark Allen Garety, Metamora, IL (US)

(73) Assignee: Caterpillar Inc., Peoria, IL (US)

(21) Appl. No.: 18/295,438

(22) Filed: Apr. 4, 2023

(51) Int. Cl. B63H 21/20; B63H 23/12

(52) U.S. Cl. CPC B63H 21/20; B63H 23/12; B63H 2021/205

(57) ABSTRACT

A propulsion system includes an engine having an engine output shaft, and an electric motor assembly including an electric motor having an output gear fixed to rotate with a driveshaft, and a disconnect clutch. The electric motor assembly further includes a common housing positioned around the electric motor and the disconnect clutch, and a fluid system including a fluid circuit for cooling and lubrication of the electric motor and the disconnect clutch. Related methodology including operating a propulsion system in a motor-only mode, an engine-only mode, and a hybrid mode is also disclosed.

### TECHNICAL FIELD

The present disclosure relates generally to a propulsion system, and more particularly to an electric motor assembly including a common housing positioned around an electric motor and a hydraulically-actuated disconnect clutch.

### BACKGROUND

A great many different propulsion system configurations are known for mobile machines, including land vehicles and marine vessels. For decades, propulsion systems were conventionally based around combustion engines including diesel and/or natural gas engines, gasoline engines, and even gas turbine engines. Electric propulsion systems have also been widely adopted for many years. More recently, various hybrid propulsion systems employing both combustion engines and electric power have seen considerable commercial success.

Current market offerings for so-called hybrid systems, especially in the marine vessel propulsion space, can often require an end user to integrate multiple disparate systems from different suppliers. As a result, end users are commonly required to identify, source, and assemble different aspects of the machinery and purchase or even customize parts. For example, individual parts of a propulsion system can also often require their own secondary systems, such as fluid supplies, cooling systems, and computer control units. In addition to the challenges of integration, installing hybrid systems concocted from different suppliers inevitably requires more than an ideal amount of space. One known hybrid population system is described in U.S. Pat. No. 6,986,727 to Kuras et al. The art provides ample opportunity for improvements and development of alternative strategies.

### SUMMARY OF THE INVENTION

In one aspect, a propulsion system includes an engine having an engine output shaft, and an electric motor assembly having an electric motor including a rotor and a stator, a driveshaft, an output gear fixed to rotate with the driveshaft, and a hydraulically-actuated disconnect clutch. The disconnect clutch is positioned operably between the driveshaft and the engine output shaft. The electric motor assembly further includes a common housing having a plurality of attached housing components together positioned around the electric motor and the disconnect clutch, and a fluid system including a fluid circuit for cooling and lubrication of at least one of the electric motor or the disconnect clutch.

In another aspect, an electric motor assembly includes an electric motor having a rotor and a stator, a driveshaft, and an output gear fixed to rotate with the driveshaft. The electric motor assembly further includes a disconnect clutch coupled to the driveshaft and structured to couple to an engine output shaft, and the disconnect clutch being adjustable from a disengaged state to an engaged state to couple the driveshaft to the engine output shaft. The electric motor assembly further includes a common housing having a clutch housing component positioned around the disconnect clutch, a geartrain housing component positioned around the output gear, and a motor housing component positioned around the electric motor and attached between the geartrain housing component and the clutch housing component.

In still another aspect, a method of operating a propulsion system includes applying a torque to a driveshaft in an electric motor in a motor-only mode of a propulsion system via energizing stator coils in the electric motor to rotate a rotor coupled to the driveshaft. The method further includes engaging a disconnect clutch positioned in a common housing with the electric motor to couple the driveshaft to an engine output shaft of an engine, and applying a torque to the driveshaft in an engine-only mode of the propulsion system via the engine output shaft while the disconnect clutch is engaged and the stator coils are deenergized. The method still further includes applying a torque to the driveshaft in a hybrid mode of the propulsion system via energizing the stator coils while the disconnect clutch is engaged, and operating a final drive in a machine via the torque applied to the driveshaft in each of the motor-only, engine-only, and hybrid modes.

### BRIEF DESCRIPTION OF THE DRAWINGS

FIG. 1 is a diagrammatic view of a machine having a propulsion system, according to one embodiment;

FIG. 2 is a schematic illustration of a propulsion system, according to one embodiment;

FIG. 3 is a diagrammatic view of an electric motor assembly for use in a propulsion system, according to one embodiment;

FIG. 4 is another diagrammatic view of the electric motor assembly;

FIG. 5 is yet another diagrammatic view of the electric motor assembly;

FIG. 6 is yet another diagrammatic view of the electric motor assembly;

FIG. 7 is yet another diagrammatic view of the electric motor assembly;

FIG. 8 is a diagrammatic view of a valve block, according to one embodiment;

FIG. 9 is another diagrammatic view of the valve block; and

FIG. 10 is a sectioned side diagrammatic view of an electric motor assembly, according to one embodiment.

### DETAILED DESCRIPTION

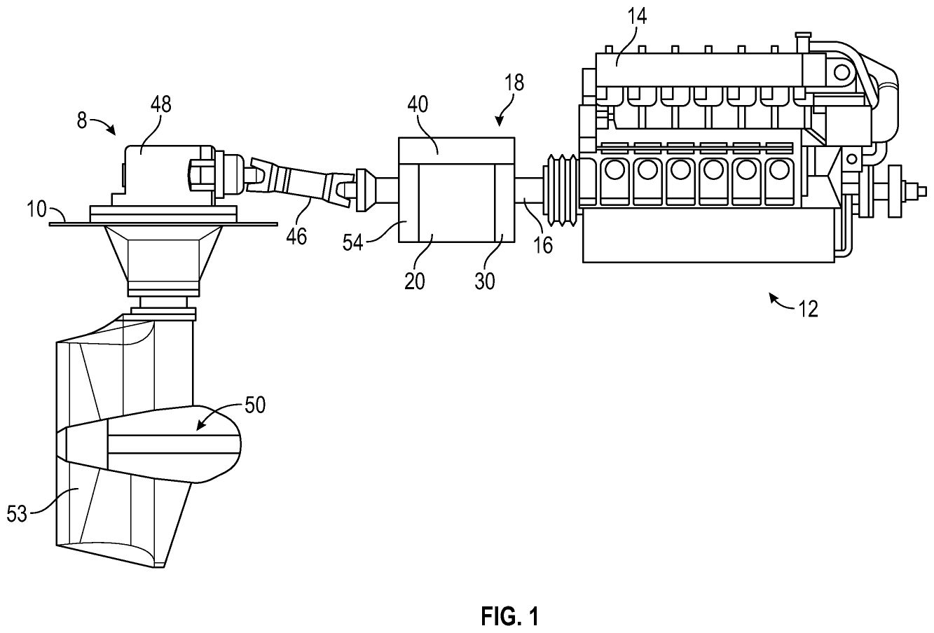

Referring to FIG. 1, there is shown a machine 8 according to one embodiment, including a frame 10 and a propulsion system 12 supported on frame 10. Machine 8 includes a marine vessel in some embodiments, such that frame 10 forms or supports a deck or hull of the marine vessel. Propulsion system 12 includes a combustion engine 14 having an engine output shaft 16. Engine 14 may include a direct-injected compression-ignition diesel engine having a plurality of combustion cylinders. In other implementations different engine configurations and operating and/or fueling and ignition strategies could be employed.

Propulsion system 12 may further include an electric motor assembly 18 having an electric motor 20, a hydraulically-actuated disconnect clutch 30, and a takeoff geartrain 54. Electric motor assembly 18 further includes a fluid system 40. Electric motor assembly 18 may be coupled to a drive coupling 46 that rotates a final drive 50. Operating final drive 50 by way of drive coupling 46 and a gearbox 48 may include operating final drive 50 coupled to a propeller 53 in a marine vessel application. In other applications final drive 50 could be coupled to one or more ground-engaging wheels or tracks, for example. As will be further apparent from the following description, the present disclosure contemplates operating propulsion system 18 in various different modes including a motor-only mode, an engine-only mode, and a hybrid mode. Fluid system 40 may be structured to provide cooling and lubrication to electric motor assembly 18, including to electric motor 20 and to disconnect clutch 30 in each of the engine-only mode, motor-only mode, and hybrid mode, the features and significance of which will be further apparent from the following description.

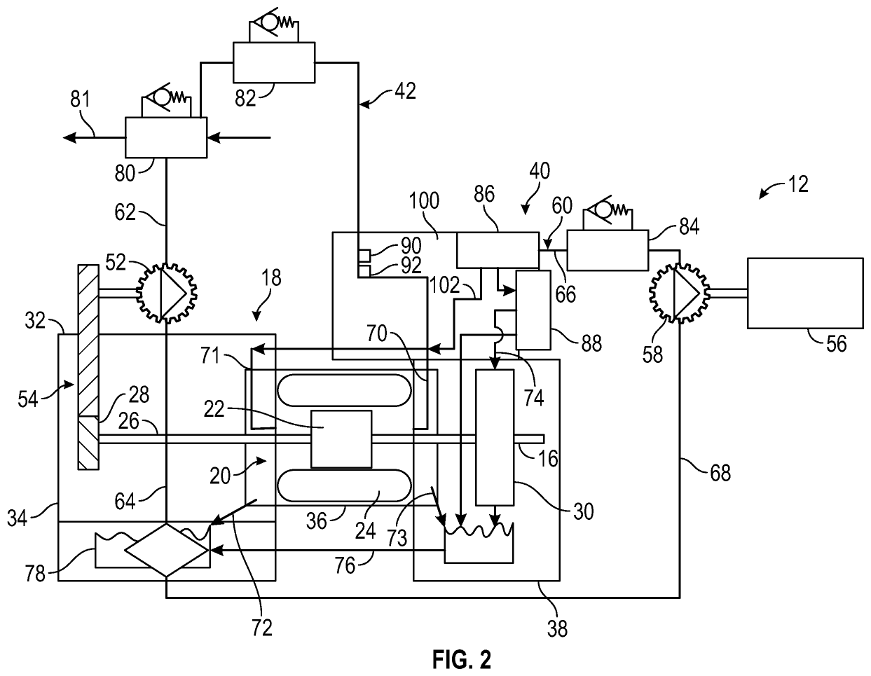

Referring also now to FIG. 2, electric motor 20 includes a rotor 22 and a stator 24, a driveshaft 26, and an output gear 28 fixed to rotate with driveshaft 26. Disconnect clutch 30 is positioned operably between driveshaft 26 and engine output shaft 16. Disconnect clutch 30 may be adjustable, via varying a pressure of a clutch actuation fluid, from a disengaged state to an engaged state to couple driveshaft 26 to engine output shaft 16. Electric motor assembly 18 may further include a common housing 32 having a plurality of attached housing components 34, 36, 38 together positioned around electric motor 20, takeoff geartrain 54, and disconnect clutch 30.

In an embodiment, common housing 32 includes a clutch housing component 38 positioned around disconnect clutch 30, a geartrain housing component 34 positioned around output gear 28, and a motor housing component 36 attached between geartrain housing component 34 and clutch housing component 38. Output gear 28 may be coupled to takeoff geartrain 54 positioned at least partially in common housing 32, in particular positioned at least partially in geartrain housing component 34.

Fluid system 40 may further include a fluid circuit 42 for cooling and lubrication of at least one of electric motor 20 or disconnect clutch 30. Fluid system 40 may also include a cooling and lubrication pump or first pump 52 rotated via takeoff geartrain 54 and mounted on common housing 32. Fluid system 40 may also include a clutch actuation pump or second pump 58 that is rotated by way of an engine geartrain 56 of engine 14. First pump 52 may include a low-pressure cooling and lubrication pump that is mounted onboard electric motor assembly 18. Second pump 58 may include a high-pressure clutch actuation pump mounted offboard electric motor assembly 18, such as mounted to an engine housing or other supporting structure associated with, or in proximity to, engine 14.

Common housing 32 may further have formed therein at least one cooling and lubrication fluid supply port, including in the illustrated embodiment a first cooling and lubrication fluid supply port 70 and a second cooling and lubrication fluid supply port 71. Common housing 32 may further include a first cooling and lubrication fluid drain 72 and a second cooling and lubrication fluid drain 73 formed therein. In the illustrated embodiment, first cooling and lubrication fluid supply port 70 is formed in clutch housing component 38 and second cooling and lubrication fluid supply port 71 is formed in geartrain housing component 34. A cooling and lubrication fluid, such as oil, may thus be conveyed into motor housing component 36 from each of clutch housing component 38 and geartrain housing component 34. First cooling and lubrication fluid drain 72 and second cooling and lubrication fluid drain 73 may be formed in geartrain housing component 34 and clutch housing component 38, respectively. Thus, cooling and lubrication fluid can drain from motor housing component 36 into geartrain housing component 34 and clutch housing component 38. Common housing 32 may still further include a clutch actuation fluid supply port 74 and a clutch actuation fluid drain 76 formed therein. A clutch actuation fluid and the cooling and lubrication fluid may be the same fluid, with the configuration of fluid system 20 enabling separated flows of the fluid to first pump 52 and second pump 58, and merged flows of the fluid returned for recirculation. Fluid system 40 may further include a common fluid sump 78 mounted on common housing 32 that receives combined flows of the drained fluid used in cooling and lubrication and clutch actuation.

As noted above, fluid system 40 may include fluid circuit 42. Fluid system 40 may also include a clutch actuation fluid circuit 60. Cooling and lubrication circuit 42 is fluidly connected to first pump 52 such that first pump 52 is arranged in cooling and lubrication circuit 42, and clutch actuation fluid circuit 60 is fluidly connected to second pump 58 such that second pump 58 is arranged in actuation fluid circuit 60. Fluid system 40 may also include an interconnect 102 formed, for example, in a valve block 100 mounted on common housing 32, fluidly connecting cooling and lubrication fluid circuit 42 to clutch actuation fluid circuit 60.

Fluid system 40 may further include a cooler 80 arranged to receive an outgoing flow of fluid from first pump 52 to be fed into common housing 32 by way of a pump outgoing conduit 62. A coolant conduit 81 may carry coolant for cooling the fluid conveyed through pump outgoing conduit 62. Fluid system 40 may also include a filter 82 filtering fluid having been cooled in cooler 80. A pressure sensor 90 and a temperature sensor 92 may be positioned on or in valve block 100 to monitor a pressure and a temperature of fluid conveyed through cooling and lubrication circuit 42. A pump supply conduit 64 includes a suction conduit and conveys fluid from common fluid sump 78 to first pump 52. Another pump outgoing conduit 66 receives fluid pumped by second pump 58 to be fed into common housing 32 and conveys the same through clutch actuation fluid circuit 60 to valve block 100, typically by way of another filter 84. A pump supply conduit 68 includes a suction conduit that conveys fluid from common fluid sump 78 to second pump 58. Cooling and lubrication fluid circuit 42 may be fluidly connected to clutch actuation fluid circuit 60 via at least one of the respective pump outgoing conduits 62 and 66 or the respective pump supply conduits 64 and 68. In the illustrated embodiment, pump outgoing conduits 62 and 66 fluidly connect circuits 42 and 60 via interconnect 102 in valve block 100, and pump supply conduits 64 and 68 fluidly connect circuits 42 and 60 via common fluid sump 78. A clutch control valve, such as a so-called ICTG valve, is shown at 88 and may be electrically actuated to vary a pressure of clutch actuation fluid supplied to clutch 30 for engaging and disengaging the same.

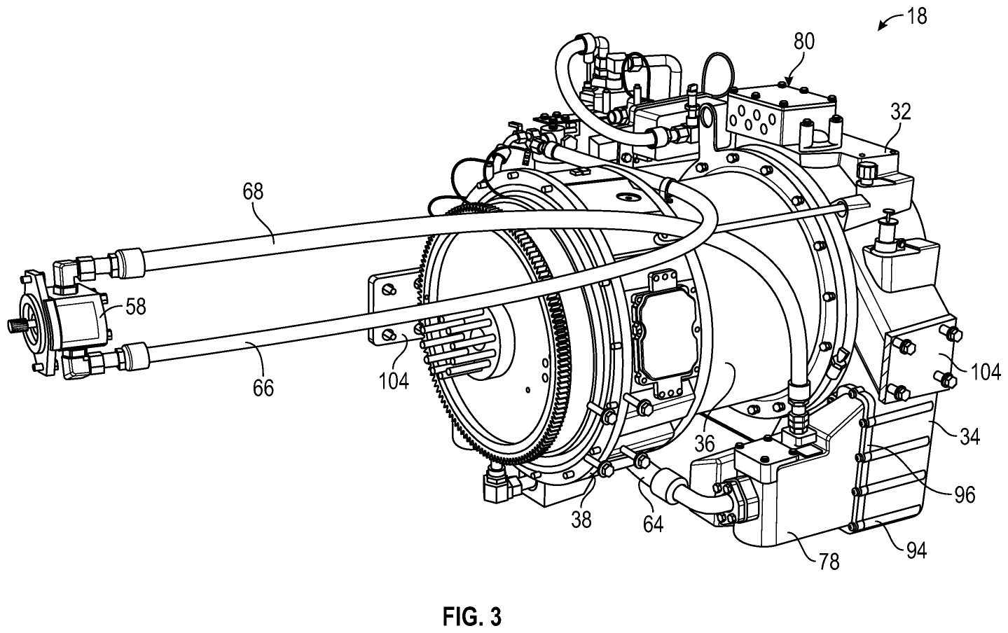

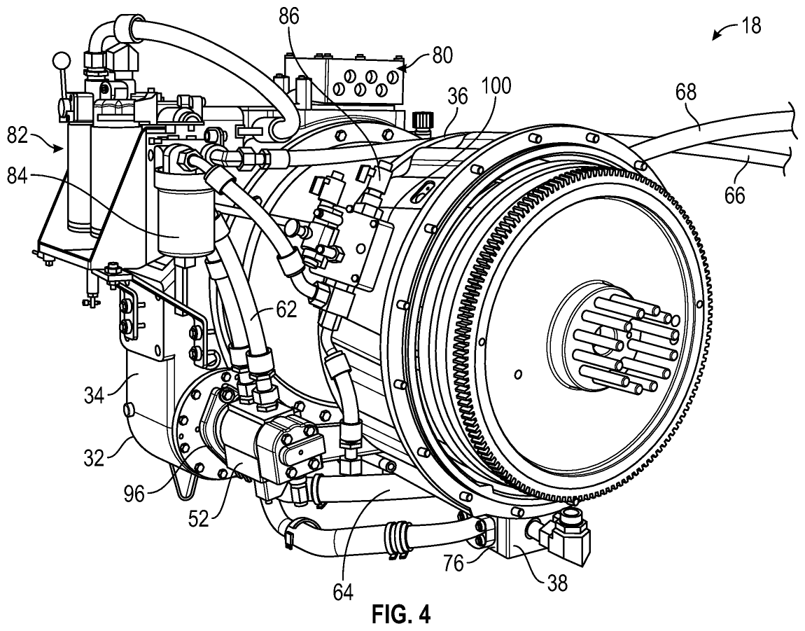

Referring also now to FIGS. 3 and 4, there are shown further features and details of an example embodiment of electric motor assembly 18. As shown in FIG. 3, common housing 32 may be attached to a first mounting bar 104 and a second mounting bar 104 attached at a first side and a second side, respectively, of common housing 32. Mounting bars 104 may be used for positioning and supporting electric motor assembly 18 onboard a machine such as a marine vessel as discussed herein. In FIG. 3, second pump 58 is shown as it might appear offboard common housing 32 to be positioned in proximity to engine 14 and coupled to engine geartrain 56. FIG. 4 shows first pump 52 mounted on common housing 32. In the illustrated embodiment mounting bars 104 attach to geartrain housing component 34, and first pump 52 is also mounted on geartrain housing component 34. Other embodiments could include different arrangements.

As also depicted in FIG. 3 common fluid sump 78 is mounted on geartrain housing component 34 upon a sump mounting face 96. FIG. 3 also shows a downwardly depending fluid collection portion 94 of geartrain housing component 34 positioned to receive cooling and lubrication fluid drained through common housing 32 under the force of gravity. Sump mounting face 96 is formed at least in part upon fluid collection portion 94. Each of pump supply conduit 64 and pump supply conduit 68 can be seen to be fluidly connected to common fluid sump 78. Common fluid sump 78 may be equipped with an internal screen filter or the like for filtering fluid in cooling and lubrication fluid circuit 42 and clutch actuation fluid circuit 60. FIGS. 3 and 4 also illustrate pump outgoing conduits 62 and 66 arranged to provide pumped fluid from the respective pumps into common housing 32 as further discussed herein.

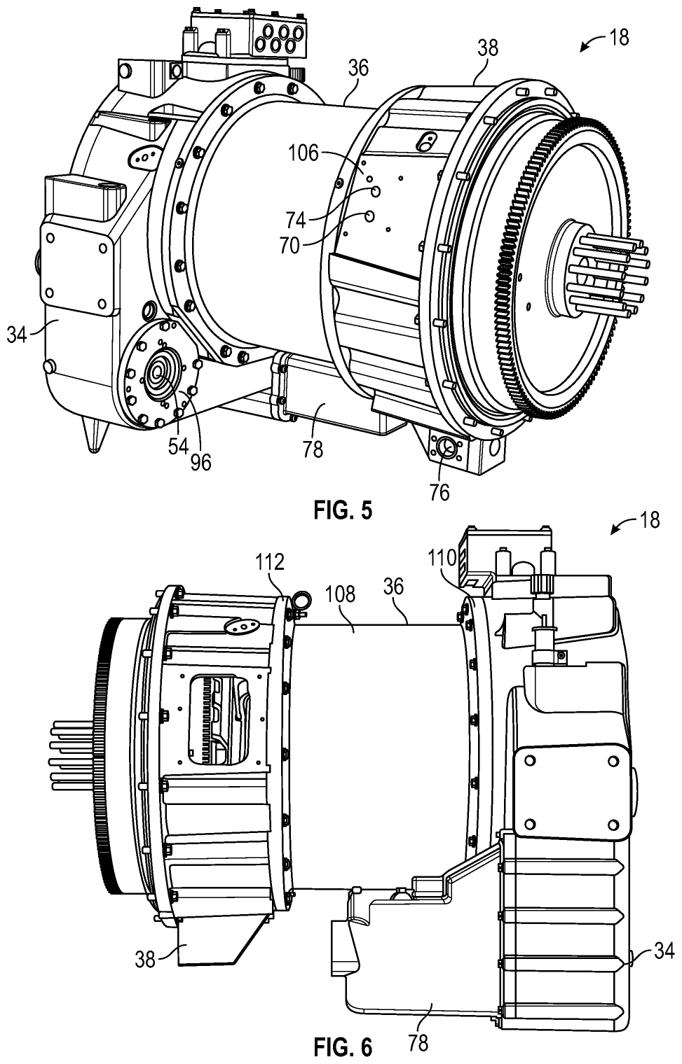

Referring now also to FIGS. 5, 6, and 7, there can be seen still further details of electric motor assembly 18. As shown in FIG. 5, clutch housing component 38 may have a valve block mounting face 106 formed thereon. Cooling and lubrication fluid supply port 70 and clutch actuation fluid supply port 74 are shown formed in valve block mounting face 106. A pump mounting face 96 is formed on geartrain housing component 34. Takeoff geartrain 54 is visible surrounded by pump mounting face 96.

As illustrated in FIG. 6 motor housing component 36 may include a first end flange 110 bolted to geartrain housing component 34, and a second end flange 112 bolted to clutch housing component 38. Motor housing component 36 may also include a cylindrical center section 108 extending from first end flange 110 to second end flange 112. In view of the present description and accompanying illustrations it can be appreciated that components of secondary systems may be mounted principally or entirely on geartrain housing component 34 or clutch housing component 38. Such a strategy allows motor housing component 36 to be selected from a range of different motor housing components, depending upon the application, and used with the same clutch housing component 38 and geartrain housing component 34. Various modifications to electric motor assembly 18 can be accommodated in this way by selecting a suitable motor housing component 36. For example, an electric motor of a relatively larger size can be positioned in a relatively larger motor housing component, whereas an electric motor of a smaller size can be arranged in a relatively smaller motor housing component. In this way, variations in the internal geometry, size, etc. of an electric motor can be accommodated by a variable size motor housing attached between the same clutch and geartrain housing components.

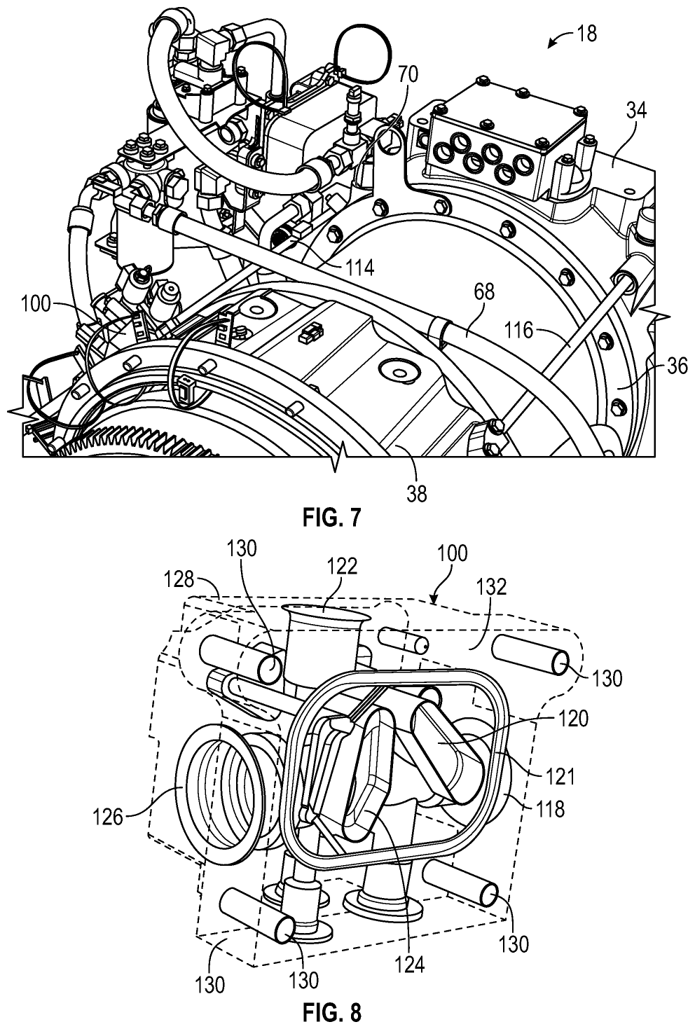

Focusing now on FIG. 7, there can be seen two externally mounted fluid conduits 114 and 116 that convey fluid from geartrain housing component 34 to clutch housing component 38. Fluid conduit 116 may supply cooling and lubrication fluid directly from geartrain housing component 34 to clutch housing component 38, and fluid conduit 114 may supply cooling and lubrication fluid directly from geartrain housing component 34 to valve block 100. Fluid conduit 114 is fluidly connected between first pump 52 and valve block 100. Cooling and lubrication fluid pumped by way of first pump 52 in cooling and lubrication circuit 42 can be conveyed into geartrain housing component 34 and then conveyed by way of external conduits 114 and 116 across or past motor housing component 36 to clutch housing component 38. As discussed above, cooling and lubrication fluid can be supplied into motor housing component 36 from the respective geartrain housing component 34 and clutch housing component 38. It will be recalled motor housing component 36 may have a range of sizes depending upon the application. Accordingly, conduits 114 and 116 may also have a variable size, with longer conduits used for a longer motor housing and shorter conduits used for a shorter motor housing. By attaching one or more conduits 114, 116 externally to geartrain housing component 34 and clutch housing component 38 the variable or selectable size of motor housing component 36 is facilitated without requirements for establishing internal fluid connections for conveyance of cooling and lubrication fluid. In this embodiment, cooling and lubrication fluid is supplied from geartrain housing component 34 to clutch housing component 38. In other embodiments a reverse pattern of fluid flow might be used to supply fluid from clutch housing component 38 to geartrain housing component 34. Bidirectional flow of cooling and lubrication fluid between geartrain housing component 34 and clutch housing component 38 would also be within the scope of the present disclosure.

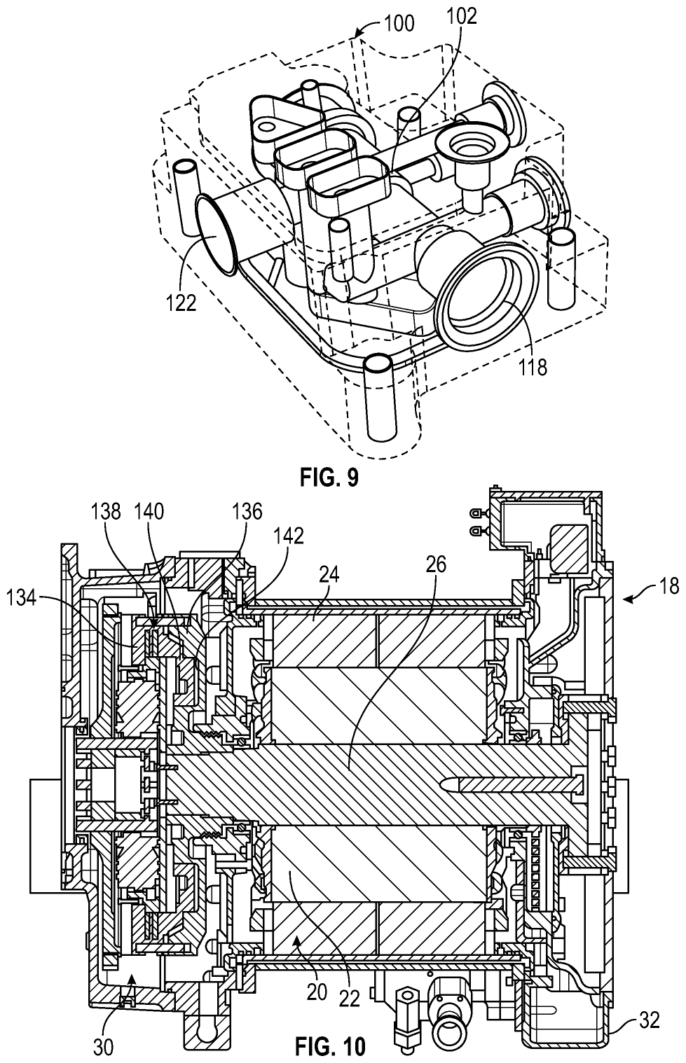

Referring also now to FIGS. 8 and 9, there are shown different views of valve block 100. Valve block 100 includes a block body 128 having a contact face 132 structured to be positioned against valve block mounting face 106. Threaded bolting holes 130 extend through block body 128 for bolting valve block 100 to clutch housing component 38. A seal groove 121 is formed in contact face 132 to receive a seal to fluidly seal around a high-pressure outlet 120 for conveying clutch actuation fluid to port 74 and a low pressure outlet 124 for conveying cooling and lubrication fluid to port 70.

It will be recalled interconnect 102 may fluidly connect cooling and lubrication fluid circuit 42 to clutch actuation fluid circuit 60. Interconnect 102 may be formed in valve block 100, although it should be appreciated that other locations for interconnecting the respective fluid circuits are contemplated, such as within common housing 32 or even between external conduits in fluid system 20. In the illustrated embodiment, a high-pressure inlet 118 forms part of clutch actuation fluid circuit 60 and receives clutch actuation fluid pumped by second pump 58. A low-pressure inlet 122 forms part of cooling and lubrication fluid circuit 42 and receives cooling and lubrication fluid pumped by first pump 52. Within valve block 100 interconnect 102 is formed by a passage that fluidly connects high-pressure inlet 118 to low pressure inlet 122.

Fluid system 40 may also include a pressure relief valve 86. Pressure relief valve 86 may be configured to open in response to excess pressure in clutch actuation fluid circuit 60 to permit relieving the excess pressure, for example, to port 70. When clutch actuation fluid pressure drops, such as when engine 14 is shut down and second pump 58 turned off, some fluid from cooling and lubrication fluid circuit 42 can flow by way of interconnect 102 into the high-pressure side of fluid system 20, providing cooling and lubrication fluid to port 74 and thus at least some cooling and lubrication fluid to clutch 30. As a result, even when clutch 30 is disengaged and no flow of high-pressure clutch actuation fluid provided clutch 30 still sees some cooling and lubrication fluid flow.

### INDUSTRIAL APPLICABILITY

Still referring to the drawings generally, but also now to FIG. 10, there is shown a sectioned side view of electric motor assembly 18 illustrating additional features and details thereof. As depicted in FIG. 10, disconnect clutch 30 may include a first rotatable component 134 structured to rotate with engine output shaft 16, and a second rotatable component structured to rotate with driveshaft 26. Clutch 30 also includes clutch friction elements 138, and a piston 140 exposed to a fluid pressure of a clutch actuation fluid cavity 142. Varying a pressure of the clutch actuation fluid supplied to fluid cavity 142 can engage or disengage clutch friction elements 138 and rotatably couple or de-couple first rotatable component 134 and second rotatable 136.

The capability to selectively couple engine output shaft 16 to driveshaft 26 enables several different operating modes of propulsion system 12 as suggested above. In an embodiment, propulsion system 12 can be operated in an engine-only mode, a motor-only mode, and a hybrid mode. Electric motor 20 may in some embodiments operate as a motor-generator unit, or MGU, enabling rotation of driveshaft 26 to generate electrical power that can be utilized onboard machine 8 and/or stored in an onboard energy storage device, for example. Engine 14 could be used to rotate electric motor 20 or electric motor 20 regeneratively rotated by retarding machine 8.

In an embodiment, operating propulsion system 12 can include applying a torque to driveshaft 26 in a motor-only mode of propulsion system 12 while disconnect clutch 30 is disengaged, via energizing stator coils 24 in electric motor 20 to rotate rotor 22 coupled to driveshaft 26. Operating propulsion system 12 may also include engaging disconnect clutch 30 positioned in common housing 32 with electric motor 20 to couple driveshaft 26 to engine output shaft 16. With disconnect clutch 30 engaged, a torque can be applied to driveshaft 26 in an engine-only mode of propulsion system 12 via engine output shaft 16 while stator coils 24 are deenergized. In a hybrid mode, a torque can be applied to driveshaft 26 via energizing stator coils 24 while disconnect clutch 30 is engaged. Final drive 50 may be operated via the torque applied to driveshaft 26 in each of the motor-only, engine-only, and hybrid modes.

It will thus be appreciated that propulsion system 12 can be switched among the modes by engaging or disengaging disconnect clutch 30 by varying a pressure of fluid for actuating disconnect clutch 30 and by selectively energizing coils of stator 24. Torque can be applied to driveshaft 26 with engine 10 alone, with energized stator coils 24 alone, or both. First pump 52 is operated via rotation of driveshaft 26 both while disconnect clutch 30 is engaged and while disconnect clutch 30 is disengaged. Accordingly, fluid for cooling and lubrication is supplied to both electric motor 20 and disconnect clutch 30 based on operating first pump 52 regardless of the particular operating mode of propulsion system 12.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A propulsion system comprising:
an engine including an engine output shaft;
an electric motor assembly including an electric motor having a rotor and a stator, a driveshaft, an output gear fixed to rotate with the driveshaft, and a hydraulically-actuated disconnect clutch positioned operably between the driveshaft and the engine output shaft; and
the electric motor assembly further including a common housing having a plurality of attached housing components together positioned around the electric motor and the disconnect clutch, and a fluid system including a fluid circuit for cooling and lubrication of at least one of the electric motor or the disconnect clutch.

2. The system of claim 1 wherein the output gear is coupled to a takeoff geartrain positioned at least partially in the common housing.

3. The system of claim 2 wherein the fluid system further includes a pump rotated via the takeoff geartrain and mounted on the common housing.

4. The system of claim 3 wherein the pump includes a low-pressure cooling and lubrication pump, and the fluid system further includes a high-pressure clutch actuation pump.

5. The system of claim 1 wherein the common housing further includes a cooling and lubrication fluid supply port, a cooling and lubrication fluid drain, a clutch actuation fluid supply port, a clutch actuation fluid drain, and a common fluid sump mounted on the common housing.

6. The system of claim 1 wherein the plurality of housing components includes a clutch housing component, a geartrain housing component, and a motor housing component attached between the clutch housing component and the geartrain housing component.

7. An electric motor assembly comprising:
an electric motor including a rotor and a stator, a driveshaft, and an output gear fixed to rotate with the driveshaft;
a disconnect clutch coupled to the driveshaft and adjustable from a disengaged state to an engaged state to couple the driveshaft to an engine output shaft; and
a common housing including a clutch housing component positioned around the disconnect clutch, a geartrain housing component positioned around the output gear, and a motor housing component positioned around the electric motor and attached between the geartrain housing component and the clutch housing component.

8. The electric motor assembly of claim 7 wherein the common housing further has formed therein at least one cooling and lubrication fluid supply port, and an actuation fluid supply port for actuating the disconnect clutch.

9. The electric motor assembly of claim 7 further comprising a first mounting bar attached at a first side of the housing and a second mounting bar attached at an opposite side of the housing.

10. The electric motor assembly of claim 7 wherein the geartrain housing component includes a pump mounting face and a sump mounting face.

11. The electric motor assembly of claim 10 wherein the geartrain housing component includes a downwardly depending fluid collection portion positioned to receive cooling and lubrication fluid drained through the common housing under the force of gravity, and the sump mounting face is formed at least in part upon the fluid collection portion.

12. The electric motor assembly of claim 10 wherein the clutch housing component includes a valve block mounting face.

13. The electric motor assembly of claim 12 wherein the at least one cooling and lubrication fluid supply port and the actuation fluid supply port are formed in the valve block mounting face.

14. The electric motor assembly of claim 7 further comprising a geartrain including the output gear and positioned in the geartrain housing component.

15. The electric motor assembly of claim 7 wherein the motor housing component includes a first end flange bolted to the geartrain housing component, and a second end flange bolted to the clutch housing component.

16. The electric motor assembly of claim 15 wherein the motor housing component includes a cylindrical center section extending from the first end flange to the second end flange.

17. A method of operating a propulsion system comprising:
applying a torque to a driveshaft in an electric motor in a motor-only mode of a propulsion system via energizing stator coils in the electric motor to rotate a rotor coupled to the driveshaft;
engaging a disconnect clutch positioned in a common housing with the electric motor to couple the driveshaft to an engine output shaft of an engine;
applying a torque to the driveshaft in an engine-only mode of the propulsion system via the engine output shaft while the disconnect clutch is engaged and the stator coils are deenergized;
applying a torque to the driveshaft in a hybrid mode of the propulsion system via energizing the stator coils while the disconnect clutch is engaged; and
operating a final drive in a machine via the torque applied to the driveshaft in each of the motor-only, engine-only, and hybrid modes.

18. The method of claim 17 wherein the operating a final drive includes operating a final drive coupled to a propeller in a marine vessel.

19. The method of claim 17 further comprising operating a cooling and lubrication fluid pump for the electric motor arranged in a lubrication fluid circuit, and operating an actuation fluid pump for the disconnect clutch arranged in an actuation fluid circuit, and the lubrication fluid circuit and the actuation fluid circuit sharing a common fluid sump.

20. The method of claim 19 wherein the operating the cooling and lubrication fluid pump includes operating the cooling and lubrication fluid pump via a takeoff geartrain of the electric motor, and the operating the actuation fluid pump includes operating the actuation fluid pump via a geartrain of the engine.
